(19) United States
(12) Patent Application Publication
(10) Pub. No.: US 2011/0228886 A1
(43) Pub. Date: Sep. 22, 2011

(54) FAST LINK RE-SYNCHRONIZATION FOR TIME-SLICED OFDM SIGNALS

(76) Inventors: Junqiang Li, Irvine, CA (US); Baoguo Yang, San Jose, CA (US)

(21) Appl. No.: 13/003,060

(22) PCT Filed: Jul. 8, 2009
(86) PCT No.: PCT/US09/49868

§ 371 Date: Apr. 5, 2011

Related U.S. Application Data
(60) Provisional application No. 61/078,811, filed on Jul. 8, 2008.

(30) Foreign Application Priority Data
Jul. 8, 2008 (US) 61078811

(51) Int. Cl. H04L 7/04

(52) U.S. Cl. 375/359

(57) ABSTRACT

Methods having corresponding apparatus and computer-readable media comprise: receiving an estimated frame index, and an estimated symbol index, for a time-sliced OFDM signal; identifying a plurality of possible frame indexes, and a plurality of possible symbol indexes, based on the estimated frame index and the estimated symbol index; selecting a plurality of possible forward error correction code offsets based on the possible frame indexes and the possible symbol indexes; and selecting one of the possible frame indexes, and one of the possible symbol indexes, based on the possible forward error correction code offsets and a SYNC byte of the time-sliced OFDM signal.

### CROSS-REFERENCE TO RELATED APPLICATIONS

This application claims benefit of U.S. Provisional Patent Application Ser. No. 61/078,811 filed Jul. 8, 2008, the disclosure thereof incorporated by reference herein in its entirety.

### FIELD

The present disclosure relates generally to receiver synchronization for receiving wireless signals. More particularly, the present disclosure relates to receiver link re-synchronization for time-sliced orthogonal frequency-division multiplexing communication systems.

### BACKGROUND

Wireless mobile communications devices such as mobile telephones are now increasingly used to receive and display digital video. Wireless communication technologies are being used to deliver this high-bandwidth content to the mobile devices. One such technology is orthogonal frequency-division multiplexing (OFDM). To conserve power in mobile receivers, some OFDM signals are time-sliced. These signals transmit data in bursts. A receiver can reduce power between bursts, and power up again to process each burst. To do this efficiently, the receiver needs knowledge of the start time for each burst. Determining these start times is referred to as link re-synchronization.

### SUMMARY

In general, in one aspect, an embodiment features a method comprising: receiving an estimated frame index, and an estimated symbol index, for a time-sliced OFDM signal; identifying a plurality of possible frame indexes, and a plurality of possible symbol indexes, based on the estimated frame index and the estimated symbol index; selecting a plurality of possible forward error correction code offsets based on the possible frame indexes and the possible symbol indexes; and selecting one of the possible frame indexes, and one of the possible symbol indexes, based on the possible forward error correction code offsets and a SYNC byte of the time-sliced OFDM signal.

Embodiments of the method can include one or more of the following features. Some embodiments comprise re-synchronizing a receiver of the OFDM signal based on the one of the possible frame indexes and the one of the possible symbol indexes. Some embodiments comprise displaying content of the OFDM signal based on the re-synchronizing. In some embodiments, the OFDM signal comprises a DVB-H signal. In some embodiments, selecting one of the possible frame indexes, and one of the possible symbol indexes, comprises: correlating the SYNC byte with a plurality of transport stream packets of the OFDM signal according to each of the possible forward error correction code offsets.

In general, in one aspect, an embodiment features an apparatus comprising: an input module to receive an estimated frame index, and an estimated symbol index, for a time-sliced OFDM signal; an index module to identify a plurality of possible frame indexes, and a plurality of possible symbol indexes, based on the estimated frame index and the estimated symbol index; an offset module to select a plurality of possible forward error correction code offsets based on the possible frame indexes and the possible symbol indexes; and a synchronization module to select one of the possible frame indexes, and one of the possible symbol indexes, based on the possible forward error correction code offsets and a SYNC byte of the time-sliced OFDM signal.

Embodiments of the apparatus can include one or more of the following features. Some embodiments comprise a timing module to re-synchronize a receiver of the OFDM signal based on the one of the possible frame indexes and the one of the possible symbol indexes. Some embodiments comprise a display to display content of the OFDM signal based on the one of the possible frame indexes and the one of the possible symbol indexes. In some embodiments, the OFDM signal comprises a DVB-H signal. In some embodiments, the synchronization module comprises: a correlator to correlate the SYNC byte with a plurality of transport stream packets of the OFDM signal according to each of the possible forward error correction code offsets.

In general, in one aspect, an embodiment features computer-readable media embodying instructions executable by a computer to perform a method comprising: receiving an estimated frame index, and an estimated symbol index, for a time-sliced OFDM signal; identifying a plurality of possible frame indexes, and a plurality of possible symbol indexes, based on the estimated frame index and the estimated symbol index; selecting a plurality of possible forward error correction code offsets based on the possible frame indexes and the possible symbol indexes; and selecting one of the possible frame indexes, and one of the possible symbol indexes, based on the possible forward error correction code offsets and a SYNC byte of the time-sliced OFDM signal.

Embodiments of the computer-readable media can include one or more of the following features. In some embodiments, the method further comprises: re-synchronizing a receiver of the OFDM signal based on the one of the possible frame indexes and the one of the possible symbol indexes. In some embodiments, the method further comprises: displaying content of the OFDM signal based on the re-synchronizing. In some embodiments, the OFDM signal comprises a DVB-H signal. In some embodiments, selecting one of the possible frame indexes, and one of the possible symbol indexes, comprises: correlating the SYNC byte with a plurality of transport stream packets of the OFDM signal according to each of the possible forward error correction code offsets.

The details of one or more implementations are set forth in the accompanying drawings and the description below. Other features will be apparent from the description and drawings, and from the claims.

### DESCRIPTION OF DRAWINGS

FIG. 1 shows elements of a wireless data communication system comprising a wireless communication device receiving wireless OFDM signals from a transmitter according to some embodiments.

FIG. 2 shows elements of the wireless communication device of FIG. 1 according to some embodiments.

FIG. 3 shows a re-synchronization process for the wireless communication device of FIG. 2 according to some embodiments.

FIG. 4 shows example code for Reed-Solomon code bit offset estimation.

The leading digit(s) of each reference numeral used in this specification indicates the number of the drawing in which the reference numeral first appears.

### DETAILED DESCRIPTION

Embodiments of the present disclosure provide fast re-synchronization for time-sliced orthogonal frequency-division multiplexing (OFDM) signals. One such signal is DVB-H (Digital Video Broadcasting—Handheld) in time-slice mode. Various embodiments are described with reference to DVB-H signals. However, the disclosed techniques apply to other OFDM signals as well, as will be apparent after reading this disclosure.

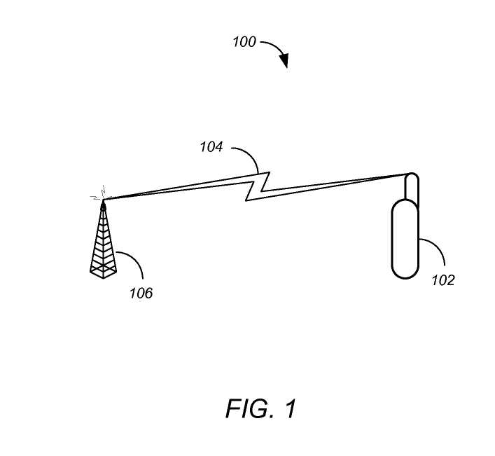

FIG. 1 shows elements of a wireless data communication system 100 comprising a wireless communication device 102 receiving wireless OFDM signals 104 from a transmitter 106 according to some embodiments. Although in the described embodiments, the elements of wireless data communication system 100 are presented in one arrangement, other embodiments may feature other arrangements, as will be apparent to one skilled in the relevant arts based on the disclosure and teachings provided herein. For example, the elements of wireless data communication system 100 can be implemented in hardware, software, or combinations thereof.

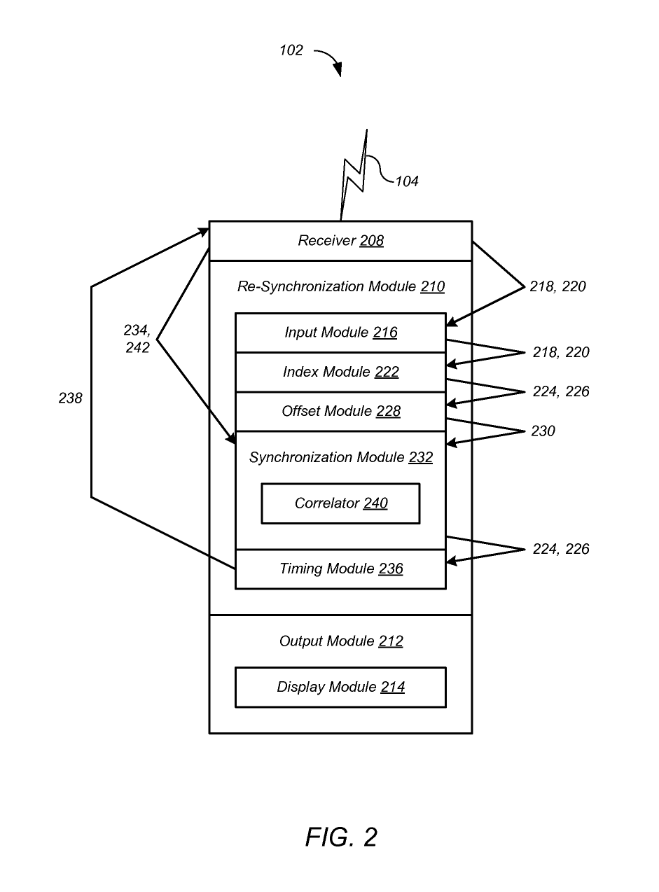

FIG. 2 shows elements of wireless communication device 102 of FIG. 1 according to some embodiments. Although in the described embodiments, the elements of wireless communication device 102 are presented in one arrangement, other embodiments may feature other arrangements, as will be apparent to one skilled in the relevant arts based on the disclosure and teachings provided herein. For example, the elements of wireless communication device 102 can be implemented in hardware, software, or combinations thereof. For example, wireless communication device 102 can be implemented as a mobile phone, a personal digital assistant (PDA), a personal computer, and the like.

Referring to FIG. 2, wireless communication device 102 includes a receiver 208 to receive wireless OFDM signals 104, which can include DVB-H signals or the like. Wireless communication device 102 also includes a re-synchronization module 210 to re-synchronize receiver 208 and an output module 212 to output content of OFDM signals 104. Output module 212 includes a display 214 to display content of OFDM signals 104. Re-synchronization module 210 includes an input module 216 to receive an estimated frame index 218, and an estimated symbol index 220, for OFDM signals 104; an index module 222 to select a plurality of possible frame indexes 224, and a plurality of possible symbol indexes 226, based on estimated frame index 218 and estimated symbol index 220; an offset module 228 to select a plurality of possible forward error correction code offsets 230 based on possible frame indexes 224 and possible symbol indexes 226; a synchronization module 232 to select one of possible frame indexes 224, and one of possible symbol indexes 226, based on possible forward error correction code offsets 230 and a SYNC byte 234 of OFDM signals 104, and a timing module 236 to re-synchronize receiver 208 using one or more re-synchronization signals 238 based on selected frame index 224 and selected symbol index 226. Synchronization module 232 includes a correlator 240 to correlate SYNC byte 234 with a plurality of transport stream packets 242 of OFDM signal 104 according to each of possible forward error correction code offsets 230.

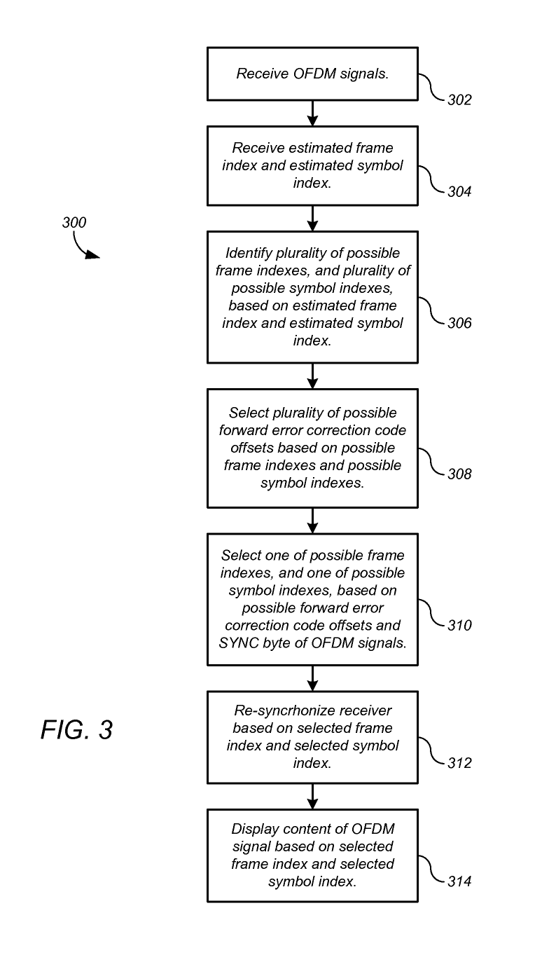

FIG. 3 shows a re-synchronization process 300 for wireless communication device 102 of FIG. 2 according to some embodiments. Although in the described embodiments, the elements of the processes disclosed herein are presented in one arrangement, other embodiments may feature other arrangements, as will be apparent to one skilled in the relevant arts based on the disclosure and teachings provided herein. For example, in various embodiments, some or all of the steps of the disclosed processes can be executed in a different order, concurrently, and the like.

Referring to FIG. 3, receiver 208 receives OFDM signals 104 (step 302). In some embodiments, signals 104 include DVB-H signals. Based on signals 104, receiver 208 generates estimated frame index 218 and estimated symbol index 220, for example according to conventional techniques.

Input module 216 of re-synchronization module 210 receives estimated frame index 218 and estimated symbol index 220 (step 304). Based on estimated frame index 218 and estimated symbol index 220, index module 222 of re-synchronization module 210 identifies a plurality of possible frame indexes 224, and a plurality of possible symbol indexes 226 (step 306). Based on possible frame indexes 224 and possible symbol indexes 226, offset module 228 selects a plurality of possible forward error correction code offsets 230 (step 308).

These identifications and selections can be based on the known patterns of the forward error correction code used in OFDM signal 104. For example, Tables 1-9 at the end of this disclosure show the known relationships between the Reed-Solomon Code Block Index (#RS block) and Offset (#Offset) for DVB-H signals. Tables 1-3 show the known relationships for 8K mode for Quadrature phase-shift keying (QPSK), 16QAM (Quadrature amplitude modulation), and 64QAM, respectively. Tables 4-6 show the known relationships for 2K mode for QPSK, 16QAM, and 64QAM, respectively. Tables 4-6 show the known relationships for 4K mode for QPSK, 16QAM, and 64QAM, respectively. According to the pattern for the RS code offset within 0-67 symbols (that is, one frame) in Table 1, the minimum repeat period of the RS code is 17 symbols. The possible repeat periods are 17, 34, 68 symbols, etc. Because the scattered pilot pattern is repeated every 4 symbols, the correct RS code offset can be selected if estimated symbol index 220 in the frame (that is, the approximate wake up time) is within +/−34 symbols.

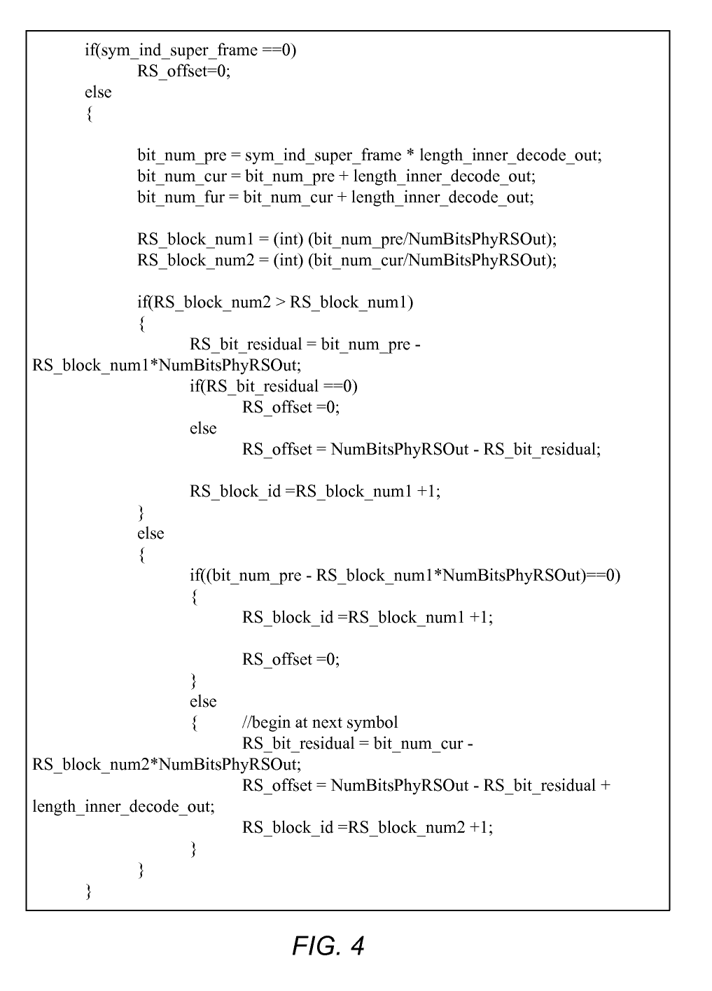

Synchronization module 232 selects one of possible frame indexes 224, and one of possible symbol indexes 226, based on possible forward error correction code offsets 230 and a SYNC byte 234 of OFDM signals 104 (step 310). In particular, correlator 240 correlates SYNC byte 234 with a plurality of transport stream packets 242 of OFDM signal 104 according to each of possible forward error correction code offsets 230. For example, with DVB-H signals, in order to decide to which possible symbol index 226 is correct, SYNC byte 234 is used to verify because different symbol indexes are mapped to different RS code bit offsets, as shown in Tables 1-9. The first byte from the estimated RS code bit offset is SYNC byte 234. An 8-bit correlation can be applied to all 17 possible RS code offsets, and the absolute correlation value can be accumulated over N times (that is, N transport stream (TS) packets, where each TS packet has one SYNC byte 234 at the head position). Considering time diversity, this N accumulated 8-bit correlation is repeated by M times for verification. An average value is calculated for each RS code offset position among the M accumulated correlation elements. The accumulated correlation elements with values larger than the average value are taken as effective elements for further processing. By doing so, the even/odd de-interleave pattern in 2K mode can be resolved. It should be noted that the N TS packet number is equal to the TS packet number in each OFDM symbol in 2K mode. Furthermore, the average value of the effective elements is calculated for all 17 RS code offset positions. Among the 17 average values of the effective elements, the maximum value is obtained to indicate the correct RS offset with a value larger than a threshold 5/8*8*N (meaning 5 bits correct among the 8 bits of SYNC byte 234). Based on this information, synchronization module 232 selects the correct frame index 224 and the correct symbol index 226. FIG. 4 shows example code for the RS code bit offset estimation.

Referring again to FIG. 3, timing module 236 re-synchronizes receiver 208 based on selected frame index 224 and selected symbol index 226 (step 312). For example, timing module 236 provides the needed information to receiver 208 with re-synchronization signals 238. Based on selected frame index 224 and selected symbol index 226, display 214 of output module 212 displays content of OFDM signal 104 (step 314).

TABLE 1

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 4 | 480 | 5 | 96 | 6 | 720 | 7 | 1344 | 7 | 840 |
| 8 | 960 | 10 | 192 | 12 | 1440 | 13 | 1056 | 13 | 48 |
| 12 | 1440 | 15 | 288 | 17 | 528 | 19 | 768 | 20 | 888 |
| 15 | 288 | 20 | 384 | 23 | 1248 | 25 | 480 | 26 | 96 |
| 19 | 768 | 25 | 480 | 28 | 336 | 31 | 192 | 33 | 936 |
| 23 | 1248 | 30 | 576 | 34 | 1056 | 38 | 1536 | 39 | 144 |
| 26 | 96 | 35 | 672 | 39 | 144 | 44 | 1248 | 46 | 984 |
| 30 | 576 | 40 | 768 | 45 | 864 | 50 | 960 | 52 | 192 |
| 34 | 1056 | 45 | 864 | 51 | 1584 | 56 | 672 | 59 | 1032 |
| 38 | 1536 | 50 | 960 | 56 | 672 | 62 | 384 | 65 | 240 |
| 41 | 384 | 55 | 1056 | 62 | 1392 | 68 | 96 | 72 | 1080 |
| 45 | 864 | 60 | 1152 | 67 | 480 | 75 | 1440 | 78 | 288 |
| 49 | 1344 | 65 | 1248 | 73 | 1200 | 81 | 1152 | 85 | 1128 |
| 52 | 192 | 70 | 1344 | 78 | 288 | 87 | 864 | 91 | 336 |
| 56 | 672 | 75 | 1440 | 84 | 1008 | 93 | 576 | 98 | 1176 |
| 60 | 1152 | 80 | 1536 | 89 | 96 | 99 | 288 | 104 | 384 |
| 64 | 0 | 85 | 0 | 95 | 816 | 106 | 0 | 111 | 1224 |
| 67 | 480 | 89 | 96 | 101 | 1536 | 112 | 1344 | 117 | 432 |
| 71 | 960 | 94 | 192 | 106 | 624 | 118 | 1056 | 124 | 1272 |
| 75 | 1440 | 99 | 288 | 112 | 1344 | 124 | 768 | 130 | 480 |
| 78 | 288 | 104 | 384 | 117 | 432 | 130 | 480 | 137 | 1320 |
| 82 | 768 | 109 | 480 | 123 | 1152 | 136 | 192 | 143 | 528 |
| 86 | 1248 | 114 | 576 | 128 | 240 | 143 | 1536 | 150 | 1368 |
| 89 | 96 | 119 | 672 | 134 | 960 | 149 | 1248 | 156 | 576 |
| 93 | 576 | 124 | 768 | 139 | 48 | 155 | 960 | 163 | 1416 |
| 97 | 1056 | 129 | 864 | 145 | 768 | 161 | 672 | 169 | 624 |
| 101 | 1536 | 134 | 960 | 151 | 1488 | 167 | 384 | 176 | 1464 |
| 104 | 384 | 139 | 1056 | 156 | 576 | 173 | 96 | 182 | 672 |
| 108 | 864 | 144 | 1152 | 162 | 1296 | 180 | 1440 | 189 | 1512 |
| 112 | 1344 | 149 | 1248 | 167 | 384 | 186 | 1152 | 195 | 720 |
| 115 | 192 | 154 | 1344 | 173 | 1104 | 192 | 864 | 202 | 1560 |
| 119 | 672 | 159 | 1440 | 178 | 192 | 198 | 576 | 208 | 768 |
| 123 | 1152 | 164 | 1536 | 184 | 912 | 204 | 288 | 215 | 1608 |
| 127 | 0 | 169 | 0 | 190 | 0 | 211 | 0 | 221 | 816 |
| 130 | 480 | 173 | 96 | 195 | 720 | 217 | 1344 | 227 | 24 |
| 134 | 960 | 178 | 192 | 201 | 1440 | 223 | 1056 | 234 | 864 |
| 138 | 1440 | 183 | 288 | 206 | 528 | 229 | 768 | 240 | 72 |
| 141 | 288 | 188 | 384 | 212 | 1248 | 235 | 480 | 247 | 912 |
| 145 | 768 | 193 | 480 | 217 | 336 | 241 | 192 | 253 | 120 |
| 149 | 1248 | 198 | 576 | 223 | 1056 | 248 | 1536 | 260 | 960 |
| 152 | 96 | 203 | 672 | 228 | 144 | 254 | 1248 | 266 | 168 |
| 156 | 576 | 208 | 768 | 234 | 864 | 260 | 960 | 273 | 1008 |
| 160 | 1056 | 213 | 864 | 240 | 1584 | 266 | 672 | 279 | 216 |
| 164 | 1536 | 218 | 960 | 245 | 672 | 272 | 384 | 286 | 1056 |
| 167 | 384 | 223 | 1056 | 251 | 1392 | 278 | 96 | 292 | 264 |
| 171 | 864 | 228 | 1152 | 256 | 480 | 285 | 1440 | 299 | 1104 |
| 175 | 1344 | 233 | 1248 | 262 | 1200 | 291 | 1152 | 305 | 312 |
| 178 | 192 | 238 | 1344 | 267 | 288 | 297 | 864 | 312 | 1152 |
| 182 | 672 | 243 | 1440 | 273 | 1008 | 303 | 576 | 318 | 360 |
| 186 | 1152 | 248 | 1536 | 278 | 96 | 309 | 288 | 325 | 1200 |
| 190 | 0 | 253 | 0 | 284 | 816 | 316 | 0 | 331 | 408 |
| 193 | 480 | 257 | 96 | 290 | 1536 | 322 | 1344 | 338 | 1248 |
| 197 | 960 | 262 | 192 | 295 | 624 | 328 | 1056 | 344 | 456 |
| 201 | 1440 | 267 | 288 | 301 | 1344 | 334 | 768 | 351 | 1296 |
| 204 | 288 | 272 | 384 | 306 | 432 | 340 | 480 | 357 | 504 |
| 208 | 768 | 277 | 480 | 312 | 1152 | 346 | 192 | 364 | 1344 |
| 212 | 1248 | 282 | 576 | 317 | 240 | 353 | 1536 | 370 | 552 |
| 215 | 96 | 287 | 672 | 323 | 960 | 359 | 1248 | 377 | 1392 |
| 219 | 576 | 292 | 768 | 328 | 48 | 365 | 960 | 383 | 600 |
| 223 | 1056 | 297 | 864 | 334 | 768 | 371 | 672 | 390 | 1440 |
| 227 | 1536 | 302 | 960 | 340 | 1488 | 377 | 384 | 396 | 648 |
| 230 | 384 | 307 | 1056 | 345 | 576 | 383 | 96 | 403 | 1488 |
| 234 | 864 | 312 | 1152 | 351 | 1296 | 390 | 1440 | 409 | 696 |
| 238 | 1344 | 317 | 1248 | 356 | 384 | 396 | 1152 | 416 | 1536 |
| 241 | 192 | 322 | 1344 | 362 | 1104 | 402 | 864 | 422 | 744 |
| 245 | 672 | 327 | 1440 | 367 | 192 | 408 | 576 | 429 | 1584 |
| 249 | 1152 | 332 | 1536 | 373 | 912 | 414 | 288 | 435 | 792 |

TABLE 2

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 8 | 960 | 10 | 192 | 12 | 1440 | 13 | 1056 | 13 | 48 |
| 15 | 288 | 20 | 384 | 23 | 1248 | 25 | 480 | 26 | 96 |
| 23 | 1248 | 30 | 576 | 34 | 1056 | 38 | 1536 | 39 | 144 |
| 30 | 576 | 40 | 768 | 45 | 864 | 50 | 960 | 52 | 192 |
| 38 | 1536 | 50 | 960 | 56 | 672 | 62 | 384 | 65 | 240 |
| 45 | 864 | 60 | 1152 | 67 | 480 | 75 | 1440 | 78 | 288 |
| 52 | 192 | 70 | 1344 | 78 | 288 | 87 | 864 | 91 | 336 |
| 60 | 1152 | 80 | 1536 | 89 | 96 | 99 | 288 | 104 | 384 |
| 67 | 480 | 89 | 96 | 101 | 1536 | 112 | 1344 | 117 | 432 |
| 75 | 1440 | 99 | 288 | 112 | 1344 | 124 | 768 | 130 | 480 |
| 82 | 768 | 109 | 480 | 123 | 1152 | 136 | 192 | 143 | 528 |
| 89 | 96 | 119 | 672 | 134 | 960 | 149 | 1248 | 156 | 576 |
| 97 | 1056 | 129 | 864 | 145 | 768 | 161 | 672 | 169 | 624 |
| 104 | 384 | 139 | 1056 | 156 | 576 | 173 | 96 | 182 | 672 |
| 112 | 1344 | 149 | 1248 | 167 | 384 | 186 | 1152 | 195 | 720 |
| 119 | 672 | 159 | 1440 | 178 | 192 | 198 | 576 | 208 | 768 |
| 127 | 0 | 169 | 0 | 190 | 0 | 211 | 0 | 221 | 816 |
| 134 | 960 | 178 | 192 | 201 | 1440 | 223 | 1056 | 234 | 864 |
| 141 | 288 | 188 | 384 | 212 | 1248 | 235 | 480 | 247 | 912 |
| 149 | 1248 | 198 | 576 | 223 | 1056 | 248 | 1536 | 260 | 960 |
| 156 | 576 | 208 | 768 | 234 | 864 | 260 | 960 | 273 | 1008 |
| 164 | 1536 | 218 | 960 | 245 | 672 | 272 | 384 | 286 | 1056 |
| 171 | 864 | 228 | 1152 | 256 | 480 | 285 | 1440 | 299 | 1104 |
| 178 | 192 | 238 | 1344 | 267 | 288 | 297 | 864 | 312 | 1152 |
| 186 | 1152 | 248 | 1536 | 278 | 96 | 309 | 288 | 325 | 1200 |
| 193 | 480 | 257 | 96 | 290 | 1536 | 322 | 1344 | 338 | 1248 |
| 201 | 1440 | 267 | 288 | 301 | 1344 | 334 | 768 | 351 | 1296 |
| 208 | 768 | 277 | 480 | 312 | 1152 | 346 | 192 | 364 | 1344 |
| 215 | 96 | 287 | 672 | 323 | 960 | 359 | 1248 | 377 | 1392 |
| 223 | 1056 | 297 | 864 | 334 | 768 | 371 | 672 | 390 | 1440 |
| 230 | 384 | 307 | 1056 | 345 | 576 | 383 | 96 | 403 | 1488 |
| 238 | 1344 | 317 | 1248 | 356 | 384 | 396 | 1152 | 416 | 1536 |
| 245 | 672 | 327 | 1440 | 367 | 192 | 408 | 576 | 429 | 1584 |
| 253 | 0 | 337 | 0 | 379 | 0 | 421 | 0 | 442 | 0 |
| 260 | 960 | 346 | 192 | 390 | 1440 | 433 | 1056 | 454 | 48 |
| 267 | 288 | 356 | 384 | 401 | 1248 | 445 | 480 | 467 | 96 |
| 275 | 1248 | 366 | 576 | 412 | 1056 | 458 | 1536 | 480 | 144 |
| 282 | 576 | 376 | 768 | 423 | 864 | 470 | 960 | 493 | 192 |
| 290 | 1536 | 386 | 960 | 434 | 672 | 482 | 384 | 506 | 240 |
| 297 | 864 | 396 | 1152 | 445 | 480 | 495 | 1440 | 519 | 288 |
| 304 | 192 | 406 | 1344 | 456 | 288 | 507 | 864 | 532 | 336 |
| 312 | 1152 | 416 | 1536 | 467 | 96 | 519 | 288 | 545 | 384 |
| 319 | 480 | 425 | 96 | 479 | 1536 | 532 | 1344 | 558 | 432 |
| 327 | 1440 | 435 | 288 | 490 | 1344 | 544 | 768 | 571 | 480 |
| 334 | 768 | 445 | 480 | 501 | 1152 | 556 | 192 | 584 | 528 |
| 341 | 96 | 455 | 672 | 512 | 960 | 569 | 1248 | 597 | 576 |
| 349 | 1056 | 465 | 864 | 523 | 768 | 581 | 672 | 610 | 624 |
| 356 | 384 | 475 | 1056 | 534 | 576 | 593 | 96 | 623 | 672 |
| 364 | 1344 | 485 | 1248 | 545 | 384 | 606 | 1152 | 636 | 720 |
| 371 | 672 | 495 | 1440 | 556 | 192 | 618 | 576 | 649 | 768 |
| 379 | 0 | 505 | 0 | 568 | 0 | 631 | 0 | 662 | 816 |
| 386 | 960 | 514 | 192 | 579 | 1440 | 643 | 1056 | 675 | 864 |
| 393 | 288 | 524 | 384 | 590 | 1248 | 655 | 480 | 688 | 912 |
| 401 | 1248 | 534 | 576 | 601 | 1056 | 668 | 1536 | 701 | 960 |
| 408 | 576 | 544 | 768 | 612 | 864 | 680 | 960 | 714 | 1008 |
| 416 | 1536 | 554 | 960 | 623 | 672 | 692 | 384 | 727 | 1056 |
| 423 | 864 | 564 | 1152 | 634 | 480 | 705 | 1440 | 740 | 1104 |
| 430 | 192 | 574 | 1344 | 645 | 288 | 717 | 864 | 753 | 1152 |
| 438 | 1152 | 584 | 1536 | 656 | 96 | 729 | 288 | 766 | 1200 |
| 445 | 480 | 593 | 96 | 668 | 1536 | 742 | 1344 | 779 | 1248 |
| 453 | 1440 | 603 | 288 | 679 | 1344 | 754 | 768 | 792 | 1296 |
| 460 | 768 | 613 | 480 | 690 | 1152 | 766 | 192 | 805 | 1344 |
| 467 | 96 | 623 | 672 | 701 | 960 | 779 | 1248 | 818 | 1392 |
| 475 | 1056 | 633 | 864 | 712 | 768 | 791 | 672 | 831 | 1440 |
| 482 | 384 | 643 | 1056 | 723 | 576 | 803 | 96 | 844 | 1488 |
| 490 | 1344 | 653 | 1248 | 734 | 384 | 816 | 1152 | 857 | 1536 |
| 497 | 672 | 663 | 1440 | 745 | 192 | 828 | 576 | 870 | 1584 |

TABLE 3

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 12 | 1440 | 15 | 288 | 17 | 528 | 19 | 768 | 20 | 888 |
| 23 | 1248 | 30 | 576 | 34 | 1056 | 38 | 1536 | 39 | 144 |
| 34 | 1056 | 45 | 864 | 51 | 1584 | 56 | 672 | 59 | 1032 |
| 45 | 864 | 60 | 1152 | 67 | 480 | 75 | 1440 | 78 | 288 |
| 56 | 672 | 75 | 1440 | 84 | 1008 | 93 | 576 | 98 | 1176 |
| 67 | 480 | 89 | 96 | 101 | 1536 | 112 | 1344 | 117 | 432 |
| 78 | 288 | 104 | 384 | 117 | 432 | 130 | 480 | 137 | 1320 |
| 89 | 96 | 119 | 672 | 134 | 960 | 149 | 1248 | 156 | 576 |
| 101 | 1536 | 134 | 960 | 151 | 1488 | 167 | 384 | 176 | 1464 |
| 112 | 1344 | 149 | 1248 | 167 | 384 | 186 | 1152 | 195 | 720 |
| 123 | 1152 | 164 | 1536 | 184 | 912 | 204 | 288 | 215 | 1608 |
| 134 | 960 | 178 | 192 | 201 | 1440 | 223 | 1056 | 234 | 864 |
| 145 | 768 | 193 | 480 | 217 | 336 | 241 | 192 | 253 | 120 |
| 156 | 576 | 208 | 768 | 234 | 864 | 260 | 960 | 273 | 1008 |
| 167 | 384 | 223 | 1056 | 251 | 1392 | 278 | 96 | 292 | 264 |
| 178 | 192 | 238 | 1344 | 267 | 288 | 297 | 864 | 312 | 1152 |
| 190 | 0 | 253 | 0 | 284 | 816 | 316 | 0 | 331 | 408 |
| 201 | 1440 | 267 | 288 | 301 | 1344 | 334 | 768 | 351 | 1296 |
| 212 | 1248 | 282 | 576 | 317 | 240 | 353 | 1536 | 370 | 552 |
| 223 | 1056 | 297 | 864 | 334 | 768 | 371 | 672 | 390 | 1440 |
| 234 | 864 | 312 | 1152 | 351 | 1296 | 390 | 1440 | 409 | 696 |
| 245 | 672 | 327 | 1440 | 367 | 192 | 408 | 576 | 429 | 1584 |
| 256 | 480 | 341 | 96 | 384 | 720 | 427 | 1344 | 448 | 840 |
| 267 | 288 | 356 | 384 | 401 | 1248 | 445 | 480 | 467 | 96 |
| 278 | 96 | 371 | 672 | 417 | 144 | 464 | 1248 | 487 | 984 |
| 290 | 1536 | 386 | 960 | 434 | 672 | 482 | 384 | 506 | 240 |
| 301 | 1344 | 401 | 1248 | 451 | 1200 | 501 | 1152 | 526 | 1128 |
| 312 | 1152 | 416 | 1536 | 467 | 96 | 519 | 288 | 545 | 384 |
| 323 | 960 | 430 | 192 | 484 | 624 | 538 | 1056 | 565 | 1272 |
| 334 | 768 | 445 | 480 | 501 | 1152 | 556 | 192 | 584 | 528 |
| 345 | 576 | 460 | 768 | 517 | 48 | 575 | 960 | 604 | 1416 |
| 356 | 384 | 475 | 1056 | 534 | 576 | 593 | 96 | 623 | 672 |
| 367 | 192 | 490 | 1344 | 551 | 1104 | 612 | 864 | 643 | 1560 |
| 379 | 0 | 505 | 0 | 568 | 0 | 631 | 0 | 662 | 816 |
| 390 | 1440 | 519 | 288 | 584 | 528 | 649 | 768 | 681 | 72 |
| 401 | 1248 | 534 | 576 | 601 | 1056 | 668 | 1536 | 701 | 960 |
| 412 | 1056 | 549 | 864 | 618 | 1584 | 686 | 672 | 720 | 216 |
| 423 | 864 | 564 | 1152 | 634 | 480 | 705 | 1440 | 740 | 1104 |
| 434 | 672 | 579 | 1440 | 651 | 1008 | 723 | 576 | 759 | 360 |
| 445 | 480 | 593 | 96 | 668 | 1536 | 742 | 1344 | 779 | 1248 |
| 456 | 288 | 608 | 384 | 684 | 432 | 760 | 480 | 798 | 504 |
| 467 | 96 | 623 | 672 | 701 | 960 | 779 | 1248 | 818 | 1392 |
| 479 | 1536 | 638 | 960 | 718 | 1488 | 797 | 384 | 837 | 648 |
| 490 | 1344 | 653 | 1248 | 734 | 384 | 816 | 1152 | 857 | 1536 |
| 501 | 1152 | 668 | 1536 | 751 | 912 | 834 | 288 | 876 | 792 |
| 512 | 960 | 682 | 192 | 768 | 1440 | 853 | 1056 | 895 | 48 |
| 523 | 768 | 697 | 480 | 784 | 336 | 871 | 192 | 915 | 936 |
| 534 | 576 | 712 | 768 | 801 | 864 | 890 | 960 | 934 | 192 |
| 545 | 384 | 727 | 1056 | 818 | 1392 | 908 | 96 | 954 | 1080 |
| 556 | 192 | 742 | 1344 | 834 | 288 | 927 | 864 | 973 | 336 |
| 568 | 0 | 757 | 0 | 851 | 816 | 946 | 0 | 993 | 1224 |
| 579 | 1440 | 771 | 288 | 868 | 1344 | 964 | 768 | 1012 | 480 |
| 590 | 1248 | 786 | 576 | 884 | 240 | 983 | 1536 | 1032 | 1368 |
| 601 | 1056 | 801 | 864 | 901 | 768 | 1001 | 672 | 1051 | 624 |
| 612 | 864 | 816 | 1152 | 918 | 1296 | 1020 | 1440 | 1071 | 1512 |
| 623 | 672 | 831 | 1440 | 934 | 192 | 1038 | 576 | 1090 | 768 |
| 634 | 480 | 845 | 96 | 951 | 720 | 1057 | 1344 | 1109 | 24 |
| 645 | 288 | 860 | 384 | 968 | 1248 | 1075 | 480 | 1129 | 912 |
| 656 | 96 | 875 | 672 | 984 | 144 | 1094 | 1248 | 1148 | 168 |
| 668 | 1536 | 890 | 960 | 1001 | 672 | 1112 | 384 | 1168 | 1056 |
| 679 | 1344 | 905 | 1248 | 1018 | 1200 | 1131 | 1152 | 1187 | 312 |
| 690 | 1152 | 920 | 1536 | 1034 | 96 | 1149 | 288 | 1207 | 1200 |
| 701 | 960 | 934 | 192 | 1051 | 624 | 1168 | 1056 | 1226 | 456 |
| 712 | 768 | 949 | 480 | 1068 | 1152 | 1186 | 192 | 1246 | 1344 |
| 723 | 576 | 964 | 768 | 1084 | 48 | 1205 | 960 | 1265 | 600 |
| 734 | 384 | 979 | 1056 | 1101 | 576 | 1223 | 96 | 1285 | 1488 |
| 745 | 192 | 994 | 1344 | 1118 | 1104 | 1242 | 864 | 1304 | 744 |

TABLE 4

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 1 | 120 | 2 | 1248 | 2 | 996 | 2 | 744 | 2 | 618 |
| 2 | 240 | 3 | 864 | 3 | 360 | 4 | 1488 | 4 | 1236 |
| 3 | 360 | 4 | 480 | 5 | 1356 | 5 | 600 | 5 | 222 |
| 4 | 480 | 5 | 96 | 6 | 720 | 7 | 1344 | 7 | 840 |
| 5 | 600 | 7 | 1344 | 7 | 84 | 8 | 456 | 9 | 1458 |
| 6 | 720 | 8 | 960 | 9 | 1080 | 10 | 1200 | 10 | 444 |
| 7 | 840 | 9 | 576 | 10 | 444 | 11 | 312 | 12 | 1062 |
| 8 | 960 | 10 | 192 | 12 | 1440 | 13 | 1056 | 13 | 48 |
| 9 | 1080 | 12 | 1440 | 13 | 804 | 14 | 168 | 15 | 666 |
| 10 | 1200 | 13 | 1056 | 14 | 168 | 16 | 912 | 17 | 1284 |
| 11 | 1320 | 14 | 672 | 16 | 1164 | 17 | 24 | 18 | 270 |
| 12 | 1440 | 15 | 288 | 17 | 528 | 19 | 768 | 20 | 888 |
| 13 | | 17 | 1536 | 19 | 1524 | 21 | 1512 | 22 | 1506 |
| 1560 | (NULL) | 18 | 1152 | 20 | 888 | 22 | 624 | 23 | 492 |
| 13 | 48 | 19 | 768 | 21 | 252 | 24 | 1368 | 25 | 1110 |
| 14 | 168 | 20 | 384 | 23 | 1248 | 25 | 480 | 26 | 96 |
| 15 | 288 | 22 | 0 | 24 | 612 | 27 | 1224 | 28 | 714 |
| 16 | 408 | 23 | 1248 | 26 | 1608 | 28 | 336 | 30 | 1332 |
| 17 | 528 | 24 | 864 | 27 | 972 | 30 | 1080 | 31 | 318 |
| 18 | 648 | 25 | 480 | 28 | 336 | 31 | 192 | 33 | 936 |
| 19 | 768 | 26 | 96 | 30 | 1332 | 33 | 936 | 35 | 1554 |
| 20 | 888 | 28 | 1344 | 31 | 696 | 34 | 48 | 36 | 540 |
| 21 | 1008 | 29 | 960 | 32 | 60 | 36 | 792 | 38 | 1158 |
| 22 | 1128 | 30 | 576 | 34 | 1056 | 38 | 1536 | 39 | 144 |
| 23 | 1248 | 31 | 192 | 35 | 420 | 39 | 648 | 41 | 762 |
| 24 | 1368 | 33 | 1440 | 37 | 1416 | 41 | 1392 | 43 | 1380 |
| 25 | 1488 | 34 | 1056 | 38 | 780 | 42 | 504 | 44 | 366 |
| 26 | | 35 | 672 | 39 | 144 | 44 | 1248 | 46 | 984 |
| 1608 | (NULL) | 36 | 288 | 41 | 1140 | 45 | 360 | 48 | 1602 |
| 26 | 96 | 38 | 1536 | 42 | 504 | 47 | 1104 | 49 | 588 |
| 27 | 216 | 39 | 1152 | 44 | 1500 | 48 | 216 | 51 | 1206 |
| 28 | 336 | 40 | 768 | 45 | 864 | 50 | 960 | 52 | 192 |
| 29 | 456 | 41 | 384 | 46 | 228 | 51 | 72 | 54 | 810 |
| 30 | 576 | 43 | 0 | 48 | 1224 | 53 | 816 | 56 | 1428 |
| 31 | 696 | 44 | 1248 | 49 | 588 | 55 | 1560 | 57 | 414 |
| 32 | 816 | 45 | 864 | 51 | 1584 | 56 | 672 | 59 | 1032 |
| 33 | 936 | 46 | 480 | 52 | 948 | 58 | 1416 | 60 | 18 |
| 34 | 1056 | 47 | 96 | 53 | 312 | 59 | 528 | 62 | 636 |
| 35 | 1176 | 49 | 1344 | 55 | 1308 | 61 | 1272 | 64 | 1254 |
| 36 | 1296 | 50 | 960 | 56 | 672 | 62 | 384 | 65 | 240 |
| 37 | 1416 | 51 | 576 | 57 | 36 | 64 | 1128 | 67 | 858 |
| 38 | | 52 | 192 | 59 | 1032 | 65 | 240 | 69 | 1476 |
| 1536 | (NULL) | 54 | 1440 | 60 | 396 | 67 | 984 | 70 | 462 |
| 38 | 24 | 55 | 1056 | 62 | 1392 | 68 | 96 | 72 | 1080 |
| 39 | 144 | 56 | 672 | 63 | 756 | 70 | 840 | 73 | 66 |
| 40 | 264 | 57 | 288 | 64 | 120 | 72 | 1584 | 75 | 684 |
| 41 | 384 | 59 | 1536 | 66 | 1116 | 73 | 696 | 77 | 1302 |
| 42 | 504 | 60 | 1152 | 67 | 480 | 75 | 1440 | 78 | 288 |
| 43 | 624 | 61 | 768 | 69 | 1476 | 76 | 552 | 80 | 906 |
| 44 | 744 | 62 | 384 | 70 | 840 | 78 | 1296 | 82 | 1524 |
| 45 | 864 | 64 | 0 | 71 | 204 | 79 | 408 | 83 | 510 |
| 46 | 984 | 65 | 1248 | 73 | 1200 | 81 | 1152 | 85 | 1128 |
| 47 | 1104 | 66 | 864 | 74 | 564 | 82 | 264 | 86 | 114 |
| 48 | 1224 | 67 | 480 | 76 | 1560 | 84 | 1008 | 88 | 732 |
| 49 | 1344 | 68 | 96 | 77 | 924 | 85 | 120 | 90 | 1350 |
| 50 | 1464 | 70 | 1344 | 78 | 288 | 87 | 864 | 91 | 336 |
| 51 | | 71 | 960 | 80 | 1284 | 89 | 1608 | 93 | 954 |
| 1584 | (NULL) | 72 | 576 | 81 | 648 | 90 | 720 | 95 | 1572 |
| 51 | 72 (same | 73 | 192 | 82 | 12 | 92 | 1464 | 96 | 558 |
| *P | | 75 | 1440 | 84 | 1008 | 93 | 576 | 98 | 1176 |
| 52 | 192 | 76 | 1056 | 85 | 372 | 95 | 1320 | 99 | 162 |
| 53 | 312 | 77 | 672 | 87 | 1368 | 96 | 432 | 101 | 780 |
| 54 | 432 | 78 | 288 | 88 | 732 | 98 | 1176 | 103 | 1398 |
| 55 | 552 | 80 | 1536 | 89 | 96 | 99 | 288 | 104 | 384 |
| 56 | 672 | 81 | 1152 | 91 | 1092 | 101 | 1032 | 106 | 1002 |
| 57 | 792 | 82 | 768 | 92 | 456 | 102 | 144 | 108 | 1620 |
| 58 | 912 | 83 | 384 | 94 | 1452 | 104 | 888 | 109 | 606 |
| 59 | 1032 | | | | | | | | |
| 60 | 1152 | | | | | | | | |
| 61 | 1272 | | | | | | | | |
| 62 | 1392 | | | | | | | | |
| 63 | 1512 | | | | | | | | |

TABLE 5

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 2 | 240 | 3 | 864 | 3 | 360 | 4 | 1488 | 4 | 1236 |
| 4 | 480 | 5 | 96 | 6 | 720 | 7 | 1344 | 7 | 840 |
| 6 | 720 | 8 | 960 | 9 | 1080 | 10 | 1200 | 10 | 444 |
| 8 | 960 | 10 | 192 | 12 | 1440 | 13 | 1056 | 13 | 48 |
| 10 | 1200 | 13 | 1056 | 14 | 168 | 16 | 912 | 17 | 1284 |
| 12 | 1440 | 15 | 288 | 17 | 528 | 19 | 768 | 20 | 888 |
| 13 | 48 | 18 | 1152 | 20 | 888 | 22 | 624 | 23 | 492 |
| 15 | 288 | 20 | 384 | 23 | 1248 | 25 | 480 | 26 | 96 |
| 17 | 528 | 23 | 1248 | 26 | 1608 | 28 | 336 | 30 | 1332 |
| 19 | 768 | 25 | 480 | 28 | 336 | 31 | 192 | 33 | 936 |
| 21 | 1008 | 28 | 1344 | 31 | 696 | 34 | 48 | 36 | 540 |
| 23 | 1248 | 30 | 576 | 34 | 1056 | 38 | 1536 | 39 | 144 |
| 25 | 1488 | 33 | 1440 | 37 | 1416 | 41 | 1392 | 43 | 1380 |
| 26 | 96 | 35 | 672 | 39 | 144 | 44 | 1248 | 46 | 984 |
| 28 | 336 | 38 | 1536 | 42 | 504 | 47 | 1104 | 49 | 588 |
| 30 | 576 | 40 | 768 | 45 | 864 | 50 | 960 | 52 | 192 |
| 32 | 816 | 43 | 0 | 48 | 1224 | 53 | 816 | 56 | 1428 |
| 34 | 1056 | 45 | 864 | 51 | 1584 | 56 | 672 | 59 | 1032 |
| 36 | 1296 | 47 | 96 | 53 | 312 | 59 | 528 | 62 | 636 |
| 38 | 1536 | 50 | 960 | 56 | 672 | 62 | 384 | 65 | 240 |
| 39 | 144 | 52 | 192 | 59 | 1032 | 65 | 240 | 69 | 1476 |
| 41 | 384 | 55 | 1056 | 62 | 1392 | 68 | 96 | 72 | 1080 |
| 43 | 624 | 57 | 288 | 64 | 120 | 72 | 1584 | 75 | 684 |
| 45 | 864 | 60 | 1152 | 67 | 480 | 75 | 1440 | 78 | 288 |
| 47 | 1104 | 62 | 384 | 70 | 840 | 78 | 1296 | 82 | 1524 |
| 49 | 1344 | 65 | 1248 | 73 | 1200 | 81 | 1152 | 85 | 1128 |
| 51 | 1584 | 67 | 480 | 76 | 1560 | 84 | 1008 | 88 | 732 |
| 52 | 192 | 70 | 1344 | 78 | 288 | 87 | 864 | 91 | 336 |
| 54 | 432 | 72 | 576 | 81 | 648 | 90 | 720 | 95 | 1572 |
| 56 | 672 | 75 | 1440 | 84 | 1008 | 93 | 576 | 98 | 1176 |
| 58 | 912 | 77 | 672 | 87 | 1368 | 96 | 432 | 101 | 780 |
| 60 | 1152 | 80 | 1536 | 89 | 96 | 99 | 288 | 104 | 384 |
| 62 | 1392 | 82 | 768 | 92 | 456 | 102 | 144 | 108 | 1620 |
| 64 | 0 | 85 | 0 | 95 | 816 | 106 | 0 | 111 | 1224 |
| 65 | 240 | 87 | 864 | 98 | 1176 | 109 | 1488 | 114 | 828 |
| 67 | 480 | 89 | 96 | 101 | 1536 | 112 | 1344 | 117 | 432 |
| 69 | 720 | 92 | 960 | 103 | 264 | 115 | 1200 | 120 | 36 |
| 71 | 960 | 94 | 192 | 106 | 624 | 118 | 1056 | 124 | 1272 |
| 73 | 1200 | 97 | 1056 | 109 | 984 | 121 | 912 | 127 | 876 |
| 75 | 1440 | 99 | 288 | 112 | 1344 | 124 | 768 | 130 | 480 |
| 76 | 48 | 102 | 1152 | 114 | 72 | 127 | 624 | 133 | 84 |
| 78 | 288 | 104 | 384 | 117 | 432 | 130 | 480 | 137 | 1320 |
| 80 | 528 | 107 | 1248 | 120 | 792 | 133 | 336 | 140 | 924 |
| 82 | 768 | 109 | 480 | 123 | 1152 | 136 | 192 | 143 | 528 |
| 84 | 1008 | 112 | 1344 | 126 | 1512 | 139 | 48 | 146 | 132 |
| 86 | 1248 | 114 | 576 | 128 | 240 | 143 | 1536 | 150 | 1368 |
| 88 | 1488 | 117 | 1440 | 131 | 600 | 146 | 1392 | 153 | 972 |
| 89 | 96 | 119 | 672 | 134 | 960 | 149 | 1248 | 156 | 576 |
| 91 | 336 | 122 | 1536 | 137 | 1320 | 152 | 1104 | 159 | 180 |
| 93 | 576 | 124 | 768 | 139 | 48 | 155 | 960 | 163 | 1416 |
| 95 | 816 | 127 | 0 | 142 | 408 | 158 | 816 | 166 | 1020 |
| 97 | 1056 | 129 | 864 | 145 | 768 | 161 | 672 | 169 | 624 |
| 99 | 1296 | 131 | 96 | 148 | 1128 | 164 | 528 | 172 | 228 |
| 101 | 1536 | 134 | 960 | 151 | 1488 | 167 | 384 | 176 | 1464 |
| 102 | 144 | 136 | 192 | 153 | 216 | 170 | 240 | 179 | 1068 |
| 104 | 384 | 139 | 1056 | 156 | 576 | 173 | 96 | 182 | 672 |
| 106 | 624 | 141 | 288 | 159 | 936 | 177 | 1584 | 185 | 276 |
| 108 | 864 | 144 | 1152 | 162 | 1296 | 180 | 1440 | 189 | 1512 |
| 110 | 1104 | 146 | 384 | 164 | 24 | 183 | 1296 | 192 | 1116 |
| 112 | 1344 | 149 | 1248 | 167 | 384 | 186 | 1152 | 195 | 720 |
| 114 | 1584 | 151 | 480 | 170 | 744 | 189 | 1008 | 198 | 324 |
| 115 | 192 | 154 | 1344 | 173 | 1104 | 192 | 864 | 202 | 1560 |
| 117 | 432 | 156 | 576 | 176 | 1464 | 195 | 720 | 205 | 1164 |
| 119 | 672 | 159 | 1440 | 178 | 192 | 198 | 576 | 208 | 768 |
| 121 | 912 | 161 | 672 | 181 | 552 | 201 | 432 | 211 | 372 |
| 123 | 1152 | 164 | 1536 | 184 | 912 | 204 | 288 | 215 | 1608 |
| 125 | 1392 | 166 | 768 | 187 | 1272 | 207 | 144 | 218 | 1212 |

TABLE 6

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 3 | 360 | 4 | 480 | 5 | 1356 | 5 | 600 | 5 | 222 |
| 6 | 720 | 8 | 960 | 9 | 1080 | 10 | 1200 | 10 | 444 |
| 9 | 1080 | 12 | 1440 | 13 | 804 | 14 | 168 | 15 | 666 |
| 12 | 1440 | 15 | 288 | 17 | 528 | 19 | 768 | 20 | 888 |
| 14 | 168 | 19 | 768 | 21 | 252 | 24 | 1368 | 25 | 1110 |
| 17 | 528 | 23 | 1248 | 26 | 1608 | 28 | 336 | 30 | 1332 |
| 20 | 888 | 26 | 96 | 30 | 1332 | 33 | 936 | 35 | 1554 |
| 23 | 1248 | 30 | 576 | 34 | 1056 | 38 | 1536 | 39 | 144 |
| 26 | 1608 | 34 | 1056 | 38 | 780 | 42 | 504 | 44 | 366 |
| 28 | 336 | 38 | 1536 | 42 | 504 | 47 | 1104 | 49 | 588 |
| 31 | 696 | 41 | 384 | 46 | 228 | 51 | 72 | 54 | 810 |
| 34 | 1056 | 45 | 864 | 51 | 1584 | 56 | 672 | 59 | 1032 |
| 37 | 1416 | 49 | 1344 | 55 | 1308 | 61 | 1272 | 64 | 1254 |
| 39 | 144 | 52 | 192 | 59 | 1032 | 65 | 240 | 69 | 1476 |
| 42 | 504 | 56 | 672 | 63 | 756 | 70 | 840 | 73 | 66 |
| 45 | 864 | 60 | 1152 | 67 | 480 | 75 | 1440 | 78 | 288 |
| 48 | 1224 | 64 | 0 | 71 | 204 | 79 | 408 | 83 | 510 |
| 51 | 1584 | 67 | 480 | 76 | 1560 | 84 | 1008 | 88 | 732 |
| 53 | 312 | 71 | 960 | 80 | 1284 | 89 | 1608 | 93 | 954 |
| 56 | 672 | 75 | 1440 | 84 | 1008 | 93 | 576 | 98 | 1176 |
| 59 | 1032 | 78 | 288 | 88 | 732 | 98 | 1176 | 103 | 1398 |
| 62 | 1392 | 82 | 768 | 92 | 456 | 102 | 144 | 108 | 1620 |
| 64 | 120 | 86 | 1248 | 96 | 180 | 107 | 744 | 112 | 210 |
| 67 | 480 | 89 | 96 | 101 | 1536 | 112 | 1344 | 117 | 432 |
| 70 | 840 | 93 | 576 | 105 | 1260 | 116 | 312 | 122 | 654 |
| 73 | 1200 | 97 | 1056 | 109 | 984 | 121 | 912 | 127 | 876 |
| 76 | 1560 | 101 | 1536 | 113 | 708 | 126 | 1512 | 132 | 1098 |
| 78 | 288 | 104 | 384 | 117 | 432 | 130 | 480 | 137 | 1320 |
| 81 | 648 | 108 | 864 | 121 | 156 | 135 | 1080 | 142 | 1542 |
| 84 | 1008 | 112 | 1344 | 126 | 1512 | 139 | 48 | 146 | 132 |
| 87 | 1368 | 115 | 192 | 130 | 1236 | 144 | 648 | 151 | 354 |
| 89 | 96 | 119 | 672 | 134 | 960 | 149 | 1248 | 156 | 576 |
| 92 | 456 | 123 | 1152 | 138 | 684 | 153 | 216 | 161 | 798 |
| 95 | 816 | 127 | 0 | 142 | 408 | 158 | 816 | 166 | 1020 |
| 98 | 1176 | 130 | 480 | 146 | 132 | 163 | 1416 | 171 | 1242 |
| 101 | 1536 | 134 | 960 | 151 | 1488 | 167 | 384 | 176 | 1464 |
| 103 | 264 | 138 | 1440 | 155 | 1212 | 172 | 984 | 180 | 54 |
| 106 | 624 | 141 | 288 | 159 | 936 | 177 | 1584 | 185 | 276 |
| 109 | 984 | 145 | 768 | 163 | 660 | 181 | 552 | 190 | 498 |
| 112 | 1344 | 149 | 1248 | 167 | 384 | 186 | 1152 | 195 | 720 |
| 114 | 72 | 152 | 96 | 171 | 108 | 190 | 120 | 200 | 942 |
| 117 | 432 | 156 | 576 | 176 | 1464 | 195 | 720 | 205 | 1164 |
| 120 | 792 | 160 | 1056 | 180 | 1188 | 200 | 1320 | 210 | 1386 |
| 123 | 1152 | 164 | 1536 | 184 | 912 | 204 | 288 | 215 | 1608 |
| 126 | 1512 | 167 | 384 | 188 | 636 | 209 | 888 | 219 | 198 |
| 128 | 240 | 171 | 864 | 192 | 360 | 214 | 1488 | 224 | 420 |
| 131 | 600 | 175 | 1344 | 196 | 84 | 218 | 456 | 229 | 642 |
| 134 | 960 | 178 | 192 | 201 | 1440 | 223 | 1056 | 234 | 864 |
| 137 | 1320 | 182 | 672 | 205 | 1164 | 227 | 24 | 239 | 1086 |
| 139 | 48 | 186 | 1152 | 209 | 888 | 232 | 624 | 244 | 1308 |
| 142 | 408 | 190 | 0 | 213 | 612 | 237 | 1224 | 249 | 1530 |
| 145 | 768 | 193 | 480 | 217 | 336 | 241 | 192 | 253 | 120 |
| 148 | 1128 | 197 | 960 | 221 | 60 | 246 | 792 | 258 | 342 |
| 151 | 1488 | 201 | 1440 | 226 | 1416 | 251 | 1392 | 263 | 564 |
| 153 | 216 | 204 | 288 | 230 | 1140 | 255 | 360 | 268 | 786 |
| 156 | 576 | 208 | 768 | 234 | 864 | 260 | 960 | 273 | 1008 |
| 159 | 936 | 212 | 1248 | 238 | 588 | 265 | 1560 | 278 | 1230 |
| 162 | 1296 | 215 | 96 | 242 | 312 | 269 | 528 | 283 | 1452 |
| 164 | 24 | 219 | 576 | 246 | 36 | 274 | 1128 | 287 | 42 |
| 167 | 384 | 223 | 1056 | 251 | 1392 | 278 | 96 | 292 | 264 |
| 170 | 744 | 227 | 1536 | 255 | 1116 | 283 | 696 | 297 | 486 |
| 173 | 1104 | 230 | 384 | 259 | 840 | 288 | 1296 | 302 | 708 |
| 176 | 1464 | 234 | 864 | 263 | 564 | 292 | 264 | 307 | 930 |
| 178 | 192 | 238 | 1344 | 267 | 288 | 297 | 864 | 312 | 1152 |
| 181 | 552 | 241 | 192 | 271 | 12 | 302 | 1464 | 317 | 1374 |
| 184 | 912 | 245 | 672 | 276 | 1368 | 306 | 432 | 322 | 1596 |
| 187 | 1272 | 249 | 1152 | 280 | 1092 | 311 | 1032 | 326 | 186 |

TABLE 7

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 2 | 240 | 3 | 864 | 3 | 360 | 4 | 1488 | 4 | 1236 |
| 4 | 480 | 5 | 96 | 6 | 720 | 7 | 1344 | 7 | 840 |
| 6 | 720 | 8 | 960 | 9 | 1080 | 10 | 1200 | 10 | 444 |
| 8 | 960 | 10 | 192 | 12 | 1440 | 13 | 1056 | 13 | 48 |
| 10 | 1200 | 13 | 1056 | 14 | 168 | 16 | 912 | 17 | 1284 |
| 12 | 1440 | 15 | 288 | 17 | 528 | 19 | 768 | 20 | 888 |
| 13 | 48 | 18 | 1152 | 20 | 888 | 22 | 624 | 23 | 492 |
| 15 | 288 | 20 | 384 | 23 | 1248 | 25 | 480 | 26 | 96 |
| 17 | 528 | 23 | 1248 | 26 | 1608 | 28 | 336 | 30 | 1332 |
| 19 | 768 | 25 | 480 | 28 | 336 | 31 | 192 | 33 | 936 |
| 21 | 1008 | 28 | 1344 | 31 | 696 | 34 | 48 | 36 | 540 |
| 23 | 1248 | 30 | 576 | 34 | 1056 | 38 | 1536 | 39 | 144 |
| 25 | 1488 | 33 | 1440 | 37 | 1416 | 41 | 1392 | 43 | 1380 |
| 26 | 96 | 35 | 672 | 39 | 144 | 44 | 1248 | 46 | 984 |
| 28 | 336 | 38 | 1536 | 42 | 504 | 47 | 1104 | 49 | 588 |
| 30 | 576 | 40 | 768 | 45 | 864 | 50 | 960 | 52 | 192 |
| 32 | 816 | 43 | 0 | 48 | 1224 | 53 | 816 | 56 | 1428 |
| 34 | 1056 | 45 | 864 | 51 | 1584 | 56 | 672 | 59 | 1032 |
| 36 | 1296 | 47 | 96 | 53 | 312 | 59 | 528 | 62 | 636 |
| 38 | 1536 | 50 | 960 | 56 | 672 | 62 | 384 | 65 | 240 |
| 39 | 144 | 52 | 192 | 59 | 1032 | 65 | 240 | 69 | 1476 |
| 41 | 384 | 55 | 1056 | 62 | 1392 | 68 | 96 | 72 | 1080 |
| 43 | 624 | 57 | 288 | 64 | 120 | 72 | 1584 | 75 | 684 |
| 45 | 864 | 60 | 1152 | 67 | 480 | 75 | 1440 | 78 | 288 |
| 47 | 1104 | 62 | 384 | 70 | 840 | 78 | 1296 | 82 | 1524 |
| 49 | 1344 | 65 | 1248 | 73 | 1200 | 81 | 1152 | 85 | 1128 |
| 51 | 1584 | 67 | 480 | 76 | 1560 | 84 | 1008 | 88 | 732 |
| 52 | 192 | 70 | 1344 | 78 | 288 | 87 | 864 | 91 | 336 |
| 54 | 432 | 72 | 576 | 81 | 648 | 90 | 720 | 95 | 1572 |
| 56 | 672 | 75 | 1440 | 84 | 1008 | 93 | 576 | 98 | 1176 |
| 58 | 912 | 77 | 672 | 87 | 1368 | 96 | 432 | 101 | 780 |
| 60 | 1152 | 80 | 1536 | 89 | 96 | 99 | 288 | 104 | 384 |
| 62 | 1392 | 82 | 768 | 92 | 456 | 102 | 144 | 108 | 1620 |
| 64 | 0 | 85 | 0 | 95 | 816 | 106 | 0 | 111 | 1224 |
| 65 | 240 | 87 | 864 | 98 | 1176 | 109 | 1488 | 114 | 828 |
| 67 | 480 | 89 | 96 | 101 | 1536 | 112 | 1344 | 117 | 432 |
| 69 | 720 | 92 | 960 | 103 | 264 | 115 | 1200 | 120 | 36 |
| 71 | 960 | 94 | 192 | 106 | 624 | 118 | 1056 | 124 | 1272 |
| 73 | 1200 | 97 | 1056 | 109 | 984 | 121 | 912 | 127 | 876 |
| 75 | 1440 | 99 | 288 | 112 | 1344 | 124 | 768 | 130 | 480 |
| 76 | 48 | 102 | 1152 | 114 | 72 | 127 | 624 | 133 | 84 |
| 78 | 288 | 104 | 384 | 117 | 432 | 130 | 480 | 137 | 1320 |
| 80 | 528 | 107 | 1248 | 120 | 792 | 133 | 336 | 140 | 924 |
| 82 | 768 | 109 | 480 | 123 | 1152 | 136 | 192 | 143 | 528 |
| 84 | 1008 | 112 | 1344 | 126 | 1512 | 139 | 48 | 146 | 132 |
| 86 | 1248 | 114 | 576 | 128 | 240 | 143 | 1536 | 150 | 1368 |
| 88 | 1488 | 117 | 1440 | 131 | 600 | 146 | 1392 | 153 | 972 |
| 89 | 96 | 119 | 672 | 134 | 960 | 149 | 1248 | 156 | 576 |
| 91 | 336 | 122 | 1536 | 137 | 1320 | 152 | 1104 | 159 | 180 |
| 93 | 576 | 124 | 768 | 139 | 48 | 155 | 960 | 163 | 1416 |
| 95 | 816 | 127 | 0 | 142 | 408 | 158 | 816 | 166 | 1020 |
| 97 | 1056 | 129 | 864 | 145 | 768 | 161 | 672 | 169 | 624 |
| 99 | 1296 | 131 | 96 | 148 | 1128 | 164 | 528 | 172 | 228 |
| 101 | 1536 | 134 | 960 | 151 | 1488 | 167 | 384 | 176 | 1464 |
| 102 | 144 | 136 | 192 | 153 | 216 | 170 | 240 | 179 | 1068 |
| 104 | 384 | 139 | 1056 | 156 | 576 | 173 | 96 | 182 | 672 |
| 106 | 624 | 141 | 288 | 159 | 936 | 177 | 1584 | 185 | 276 |
| 108 | 864 | 144 | 1152 | 162 | 1296 | 180 | 1440 | 189 | 1512 |
| 110 | 1104 | 146 | 384 | 164 | 24 | 183 | 1296 | 192 | 1116 |
| 112 | 1344 | 149 | 1248 | 167 | 384 | 186 | 1152 | 195 | 720 |
| 114 | 1584 | 151 | 480 | 170 | 744 | 189 | 1008 | 198 | 324 |
| 115 | 192 | 154 | 1344 | 173 | 1104 | 192 | 864 | 202 | 1560 |
| 117 | 432 | 156 | 576 | 176 | 1464 | 195 | 720 | 205 | 1164 |
| 119 | 672 | 159 | 1440 | 178 | 192 | 198 | 576 | 208 | 768 |
| 121 | 912 | 161 | 672 | 181 | 552 | 201 | 432 | 211 | 372 |
| 123 | 1152 | 164 | 1536 | 184 | 912 | 204 | 288 | 215 | 1608 |
| 125 | 1392 | 166 | 768 | 187 | 1272 | 207 | 144 | 218 | 1212 |

TABLE 8

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 4 | 480 | 5 | 96 | 6 | 720 | 7 | 1344 | 7 | 840 |
| 8 | 960 | 10 | 192 | 12 | 1440 | 13 | 1056 | 13 | 48 |
| 12 | 1440 | 15 | 288 | 17 | 528 | 19 | 768 | 20 | 888 |
| 15 | 288 | 20 | 384 | 23 | 1248 | 25 | 480 | 26 | 96 |
| 19 | 768 | 25 | 480 | 28 | 336 | 31 | 192 | 33 | 936 |
| 23 | 1248 | 30 | 576 | 34 | 1056 | 38 | 1536 | 39 | 144 |
| 26 | 96 | 35 | 672 | 39 | 144 | 44 | 1248 | 46 | 984 |
| 30 | 576 | 40 | 768 | 45 | 864 | 50 | 960 | 52 | 192 |
| 34 | 1056 | 45 | 864 | 51 | 1584 | 56 | 672 | 59 | 1032 |
| 38 | 1536 | 50 | 960 | 56 | 672 | 62 | 384 | 65 | 240 |
| 41 | 384 | 55 | 1056 | 62 | 1392 | 68 | 96 | 72 | 1080 |
| 45 | 864 | 60 | 1152 | 67 | 480 | 75 | 1440 | 78 | 288 |
| 49 | 1344 | 65 | 1248 | 73 | 1200 | 81 | 1152 | 85 | 1128 |
| 52 | 192 | 70 | 1344 | 78 | 288 | 87 | 864 | 91 | 336 |
| 56 | 672 | 75 | 1440 | 84 | 1008 | 93 | 576 | 98 | 1176 |
| 60 | 1152 | 80 | 1536 | 89 | 96 | 99 | 288 | 104 | 384 |
| 64 | 0 | 85 | 0 | 95 | 816 | 106 | 0 | 111 | 1224 |
| 67 | 480 | 89 | 96 | 101 | 1536 | 112 | 1344 | 117 | 432 |
| 71 | 960 | 94 | 192 | 103 | 624 | 118 | 1056 | 124 | 1272 |
| 75 | 1440 | 99 | 288 | 112 | 1344 | 124 | 768 | 130 | 480 |
| 78 | 288 | 104 | 384 | 117 | 432 | 130 | 480 | 137 | 1320 |
| 82 | 768 | 109 | 480 | 123 | 1152 | 136 | 192 | 143 | 528 |
| 86 | 1248 | 114 | 576 | 128 | 240 | 143 | 1536 | 150 | 1368 |
| 89 | 96 | 119 | 672 | 134 | 960 | 149 | 1248 | 156 | 576 |
| 93 | 576 | 124 | 768 | 139 | 48 | 155 | 960 | 163 | 1416 |
| 97 | 1056 | 129 | 864 | 145 | 768 | 161 | 672 | 169 | 624 |
| 101 | 1536 | 134 | 960 | 151 | 1488 | 167 | 384 | 176 | 1464 |
| 104 | 384 | 139 | 1056 | 156 | 576 | 173 | 96 | 182 | 672 |
| 108 | 864 | 144 | 1152 | 162 | 1296 | 180 | 1440 | 189 | 1512 |
| 112 | 1344 | 149 | 1248 | 167 | 384 | 186 | 1152 | 195 | 720 |
| 115 | 192 | 154 | 1344 | 173 | 1104 | 192 | 864 | 202 | 1560 |
| 119 | 672 | 159 | 1440 | 178 | 192 | 198 | 576 | 208 | 768 |
| 123 | 1152 | 164 | 1536 | 184 | 912 | 204 | 288 | 215 | 1608 |
| 127 | 0 | 169 | 0 | 190 | 0 | 211 | 0 | 221 | 816 |
| 130 | 480 | 173 | 96 | 195 | 720 | 217 | 1344 | 227 | 24 |
| 134 | 960 | 178 | 192 | 201 | 1440 | 223 | 1056 | 234 | 864 |
| 138 | 1440 | 183 | 288 | 206 | 528 | 229 | 768 | 240 | 72 |
| 141 | 288 | 188 | 384 | 212 | 1248 | 235 | 480 | 247 | 912 |
| 145 | 768 | 193 | 480 | 217 | 336 | 241 | 192 | 253 | 120 |
| 149 | 1248 | 198 | 576 | 223 | 1056 | 248 | 1536 | 260 | 960 |
| 152 | 96 | 203 | 672 | 228 | 144 | 254 | 1248 | 266 | 168 |
| 156 | 576 | 208 | 768 | 234 | 864 | 260 | 960 | 273 | 1008 |
| 160 | 1056 | 213 | 864 | 240 | 1584 | 266 | 672 | 279 | 216 |
| 164 | 1536 | 218 | 960 | 245 | 672 | 272 | 384 | 286 | 1056 |
| 167 | 384 | 223 | 1056 | 251 | 1392 | 278 | 96 | 292 | 264 |
| 171 | 864 | 228 | 1152 | 256 | 480 | 285 | 1440 | 299 | 1104 |
| 175 | 1344 | 233 | 1248 | 262 | 1200 | 291 | 1152 | 305 | 312 |
| 178 | 192 | 238 | 1344 | 267 | 288 | 297 | 864 | 312 | 1152 |
| 182 | 672 | 243 | 1440 | 273 | 1008 | 303 | 576 | 318 | 360 |
| 186 | 1152 | 248 | 1536 | 278 | 96 | 309 | 288 | 325 | 1200 |
| 190 | 0 | 253 | 0 | 284 | 816 | 316 | 0 | 331 | 408 |
| 193 | 480 | 257 | 96 | 290 | 1536 | 322 | 1344 | 338 | 1248 |
| 197 | 960 | 262 | 192 | 295 | 624 | 328 | 1056 | 344 | 456 |
| 201 | 1440 | 267 | 288 | 301 | 1344 | 334 | 768 | 351 | 1296 |
| 204 | 288 | 272 | 384 | 306 | 432 | 340 | 480 | 357 | 504 |
| 208 | 768 | 277 | 480 | 312 | 1152 | 346 | 192 | 364 | 1344 |
| 212 | 1248 | 282 | 576 | 317 | 240 | 353 | 1536 | 370 | 552 |
| 215 | 96 | 287 | 672 | 323 | 960 | 359 | 1248 | 377 | 1392 |
| 219 | 576 | 292 | 768 | 328 | 48 | 365 | 960 | 383 | 600 |
| 223 | 1056 | 297 | 864 | 334 | 768 | 371 | 672 | 390 | 1440 |
| 227 | 1536 | 302 | 960 | 340 | 1488 | 377 | 384 | 396 | 648 |
| 230 | 384 | 307 | 1056 | 345 | 576 | 383 | 96 | 403 | 1488 |
| 234 | 864 | 312 | 1152 | 351 | 1296 | 390 | 1440 | 409 | 696 |
| 238 | 1344 | 317 | 1248 | 356 | 384 | 396 | 1152 | 416 | 1536 |
| 241 | 192 | 322 | 1344 | 362 | 1104 | 402 | 864 | 422 | 744 |
| 245 | 672 | 327 | 1440 | 367 | 192 | 408 | 576 | 429 | 1584 |
| 249 | 1152 | 332 | 1536 | 373 | 912 | 414 | 288 | 435 | 792 |

TABLE 9

| 1/2 | | 2/3 | | 3/4 | | 5/6 | | 7/8 | |
|---|---|---|---|---|---|---|---|---|---|
| #RS block | #Offset | #RS block | #Offset | #RS block | #Offset | #RS block | #Offset | #RS block | #Offset |
| 0 | 0 | 0 | 0 | 0 | 0 | 0 | 0 | 0 | 0 |
| 6 | 720 | 8 | 960 | 9 | 1080 | 10 | 1200 | 10 | 444 |
| 12 | 1440 | 15 | 288 | 17 | 528 | 19 | 768 | 20 | 888 |
| 17 | 528 | 23 | 1248 | 26 | 1608 | 28 | 336 | 30 | 1332 |
| 23 | 1248 | 30 | 576 | 34 | 1056 | 38 | 1536 | 39 | 144 |
| 28 | 336 | 38 | 1536 | 42 | 504 | 47 | 1104 | 49 | 588 |
| 34 | 1056 | 45 | 864 | 51 | 1584 | 56 | 672 | 59 | 1032 |
| 39 | 144 | 52 | 192 | 59 | 1032 | 65 | 240 | 69 | 1476 |
| 45 | 864 | 60 | 1152 | 67 | 480 | 75 | 1440 | 78 | 288 |
| 51 | 1584 | 67 | 480 | 76 | 1560 | 84 | 1008 | 88 | 732 |
| 56 | 672 | 75 | 1440 | 84 | 1008 | 93 | 576 | 98 | 1176 |
| 62 | 1392 | 82 | 768 | 92 | 456 | 102 | 144 | 108 | 1620 |
| 67 | 480 | 89 | 96 | 101 | 1536 | 112 | 1344 | 117 | 432 |
| 73 | 1200 | 97 | 1056 | 109 | 984 | 121 | 912 | 127 | 876 |
| 78 | 288 | 104 | 384 | 117 | 432 | 130 | 480 | 137 | 1320 |
| 84 | 1008 | 112 | 1344 | 126 | 1512 | 139 | 48 | 146 | 132 |
| 89 | 96 | 119 | 672 | 134 | 960 | 149 | 1248 | 156 | 576 |
| 95 | 816 | 127 | 0 | 142 | 408 | 158 | 816 | 166 | 1020 |
| 101 | 1536 | 134 | 960 | 151 | 1488 | 167 | 384 | 176 | 1464 |
| 106 | 624 | 141 | 288 | 159 | 936 | 177 | 1584 | 185 | 276 |
| 112 | 1344 | 149 | 1248 | 167 | 384 | 186 | 1152 | 195 | 720 |
| 117 | 432 | 156 | 576 | 176 | 1464 | 195 | 720 | 205 | 1164 |
| 123 | 1152 | 164 | 1536 | 184 | 912 | 204 | 288 | 215 | 1608 |
| 128 | 240 | 171 | 864 | 192 | 360 | 214 | 1488 | 224 | 420 |
| 134 | 960 | 178 | 192 | 201 | 1440 | 223 | 1056 | 234 | 864 |
| 139 | 48 | 186 | 1152 | 209 | 888 | 232 | 624 | 244 | 1308 |
| 145 | 768 | 193 | 480 | 217 | 336 | 241 | 192 | 253 | 120 |
| 151 | 1488 | 201 | 1440 | 226 | 1416 | 251 | 1392 | 263 | 564 |
| 156 | 576 | 208 | 768 | 234 | 864 | 260 | 960 | 273 | 1008 |
| 162 | 1296 | 215 | 96 | 242 | 312 | 269 | 528 | 283 | 1452 |
| 167 | 384 | 223 | 1056 | 251 | 1392 | 278 | 96 | 292 | 264 |
| 173 | 1104 | 230 | 384 | 259 | 840 | 288 | 1296 | 302 | 708 |
| 178 | 192 | 238 | 1344 | 267 | 288 | 297 | 864 | 312 | 1152 |
| 184 | 912 | 245 | 672 | 276 | 1368 | 306 | 432 | 322 | 1596 |
| 190 | 0 | 253 | 0 | 284 | 816 | 316 | 0 | 331 | 408 |
| 195 | 720 | 260 | 960 | 292 | 264 | 325 | 1200 | 341 | 852 |
| 201 | 1440 | 267 | 288 | 301 | 1344 | 334 | 768 | 351 | 1296 |
| 206 | 528 | 275 | 1248 | 309 | 792 | 343 | 336 | 360 | 108 |
| 212 | 1248 | 282 | 576 | 317 | 240 | 353 | 1536 | 370 | 552 |
| 217 | 336 | 290 | 1536 | 326 | 1320 | 362 | 1104 | 380 | 996 |
| 223 | 1056 | 297 | 864 | 334 | 768 | 371 | 672 | 390 | 1440 |
| 228 | 144 | 304 | 192 | 342 | 216 | 380 | 240 | 399 | 252 |
| 234 | 864 | 312 | 1152 | 351 | 1296 | 390 | 1440 | 409 | 696 |
| 240 | 1584 | 319 | 480 | 359 | 744 | 399 | 1008 | 419 | 1140 |
| 245 | 672 | 327 | 1440 | 367 | 192 | 408 | 576 | 429 | 1584 |
| 251 | 1392 | 334 | 768 | 376 | 1272 | 417 | 144 | 438 | 396 |
| 256 | 480 | 341 | 96 | 384 | 720 | 427 | 1344 | 448 | 840 |
| 262 | 1200 | 349 | 1056 | 392 | 168 | 436 | 912 | 458 | 1284 |
| 267 | 288 | 356 | 384 | 401 | 1248 | 445 | 480 | 467 | 96 |
| 273 | 1008 | 364 | 1344 | 409 | 696 | 454 | 48 | 477 | 540 |
| 278 | 96 | 371 | 672 | 417 | 144 | 464 | 1248 | 487 | 984 |
| 284 | 816 | 379 | 0 | 426 | 1224 | 473 | 816 | 497 | 1428 |
| 290 | 1536 | 386 | 960 | 434 | 672 | 482 | 384 | 506 | 240 |
| 295 | 624 | 393 | 288 | 442 | 120 | 492 | 1584 | 516 | 684 |
| 301 | 1344 | 401 | 1248 | 451 | 1200 | 501 | 1152 | 526 | 1128 |
| 306 | 432 | 408 | 576 | 459 | 648 | 510 | 720 | 536 | 1572 |
| 312 | 1152 | 416 | 1536 | 467 | 96 | 519 | 288 | 545 | 384 |
| 317 | 240 | 423 | 864 | 476 | 1176 | 529 | 1488 | 555 | 828 |
| 323 | 960 | 430 | 192 | 484 | 624 | 538 | 1056 | 565 | 1272 |
| 328 | 48 | 438 | 1152 | 492 | 72 | 547 | 624 | 574 | 84 |
| 334 | 768 | 445 | 480 | 501 | 1152 | 556 | 192 | 584 | 528 |
| 340 | 1488 | 453 | 1440 | 509 | 600 | 566 | 1392 | 594 | 972 |
| 345 | 576 | 460 | 768 | 517 | 48 | 575 | 960 | 604 | 1416 |
| 351 | 1296 | 467 | 96 | 526 | 1128 | 584 | 528 | 613 | 228 |
| 356 | 384 | 475 | 1056 | 534 | 576 | 593 | 96 | 623 | 672 |
| 362 | 1104 | 482 | 384 | 542 | 24 | 603 | 1296 | 633 | 1116 |
| 367 | 192 | 490 | 1344 | 551 | 1104 | 612 | 864 | 643 | 1560 |
| 373 | 912 | 497 | 672 | 559 | 552 | 621 | 432 | 652 | 372 |

Embodiments of the disclosure can be implemented in digital electronic circuitry, or in computer hardware, firmware, software, or in combinations of them. Embodiments of the disclosure can be implemented in a computer program product tangibly embodied in a machine-readable storage device for execution by a programmable processor; and method steps of the disclosure can be performed by a programmable processor executing a program of instructions to perform functions of the disclosure by operating on input data and generating output. The disclosure can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the disclosure have been described.

Nevertheless, it will be understood that various modifications may be made without departing from the spirit and scope of the disclosure. Accordingly, other implementations are within the scope of the following claims.

What is claimed is:

1. A method comprising:
receiving an estimated frame index, and an estimated symbol index, for a time-sliced OFDM signal;
identifying a plurality of possible frame indexes, and a plurality of possible symbol indexes, based on the estimated frame index and the estimated symbol index;
selecting a plurality of possible forward error correction code offsets based on the possible frame indexes and the possible symbol indexes; and
selecting one of the possible frame indexes, and one of the possible symbol indexes, based on the possible forward error correction code offsets and a SYNC byte of the time-sliced OFDM signal.

2. The method of claim 1, further comprising:
re-synchronizing a receiver of the OFDM signal based on the one of the possible frame indexes and the one of the possible symbol indexes.

3. The method of claim 2, further comprising:
displaying content of the OFDM signal based on the re-synchronizing.

4. The method of claim 1:
wherein the OFDM signal comprises a DVB-H signal.

5. The method of claim 1, wherein selecting one of the possible frame indexes, and one of the possible symbol indexes, comprises:
correlating the SYNC byte with a plurality of transport stream packets of the OFDM signal according to each of the possible forward error correction code offsets.

6. An apparatus comprising:
an input module to receive an estimated frame index, and an estimated symbol index, for a time-sliced OFDM signal;
an index module to identify a plurality of possible frame indexes, and a plurality of possible symbol indexes, based on the estimated frame index and the estimated symbol index;
an offset module to select a plurality of possible forward error correction code offsets based on the possible frame indexes and the possible symbol indexes; and
a synchronization module to select one of the possible frame indexes, and one of the possible symbol indexes, based on the possible forward error correction code offsets and a SYNC byte of the time-sliced OFDM signal.

7. The apparatus of claim 6, further comprising:
a timing module to re-synchronize a receiver of the OFDM signal based on the one of the possible frame indexes and the one of the possible symbol indexes.

8. The apparatus of claim 7, further comprising:
a display to display content of the OFDM signal based on the one of the possible frame indexes and the one of the possible symbol indexes.

9. The apparatus of claim 6:
wherein the OFDM signal comprises a DVB-H signal.

10. The apparatus of claim 6, wherein the synchronization module comprises:
a correlator to correlate the SYNC byte with a plurality of transport stream packets of the OFDM signal according to each of the possible forward error correction code offsets.

11. Computer-readable media embodying instructions executable by a computer to perform a method comprising:
receiving an estimated frame index, and an estimated symbol index, for a time-sliced OFDM signal;
identifying a plurality of possible frame indexes, and a plurality of possible symbol indexes, based on the estimated frame index and the estimated symbol index;
selecting a plurality of possible forward error correction code offsets based on the possible frame indexes and the possible symbol indexes; and
selecting one of the possible frame indexes, and one of the possible symbol indexes, based on the possible forward error correction code offsets and a SYNC byte of the time-sliced OFDM signal.

12. The computer-readable media of claim 11, wherein the method further comprises:
re-synchronizing a receiver of the OFDM signal based on the one of the possible frame indexes and the one of the possible symbol indexes.

13. The computer-readable media of claim 12, wherein the method further comprises:
displaying content of the OFDM signal based on the re-synchronizing.

14. The computer-readable media of claim 11:
wherein the OFDM signal comprises a DVB-H signal.

15. The computer-readable media of claim 11, wherein selecting one of the possible frame indexes, and one of the possible symbol indexes, comprises:
correlating the SYNC byte with a plurality of transport stream packets of the OFDM signal according to each of the possible forward error correction code offsets.
